(19) United States
(12) Patent Application Publication
(10) Pub. No.: US 2025/0166484 A1
(43) Pub. Date: May 22, 2025

(54) COMPUTER-IMPLEMENTED METHOD OF ALERTING A PROPERTY MANAGER OF A ROOF POOLING ISSUE

(71) Applicant: TECHNOLOGIES DOMELY, Québec (CA)

(72) Inventors: Abdelrahmane FERCHICHI, Montréal (CA); Ahmed ATOUBI, Montréal (CA); Charlphillip BOUTET, Québec (CA); Jonathan BOUCHER, Beauport (CA)

(21) Appl. No.: 18/951,774

(22) Filed: Nov. 19, 2024

Related U.S. Application Data
(60) Provisional application No. 63/600,888, filed on Nov. 20, 2023.

(51) Int. Cl. G08B 21/20; G06V 10/82; G06V 20/10

(52) U.S. Cl. CPC G08B 21/20; G06V 10/82; G06V 20/176; G06V 2201/10

(57) ABSTRACT

The computer-implemented method of alerting a property manager of a pooling issue pertaining to a roof of a building can include: providing image data including an image of the roof of the building; determining that water pooling is present in the image the roof of the building, including processing the image of the roof of the building using a trained convolutional neural network; providing contextual data pertaining to at least one of weather, history, and drain obstruction associated to the determined water pooling; determining that the determined water pooling is indicative of the pooling issue, including validating a contextual criteria against the contextual data; and transmitting an alert to the property manager contingent upon said determining that the determined water pooling is indicative of the pooling issue.

### BACKGROUND

Roofs have always been a very important part of buildings, and damage to the roof may lead to substantial damage to the building itself or to assets inside the building. It is known that excessive accumulation of precipitations, either in the form of water pooling or snow, can be a source of damage to the roof. For instance, if drainage passages extending away from a flat roof become clogged and substantial rainfall occurs, the rain may pool on the flat roof to an extent where its weight may eventually exceed the building structure's support capacity. The cost associated with such damage can be high enough to motivate building owners to establish roof monitoring strategies. Indeed, while implementing a roof monitoring strategy may be a significant source of cost, such costs may be deemed acceptable when considering the risk of roof damage against which the roof monitoring strategy is intended to protect. This being said, there can remain a motivation for the roof monitoring strategy to a) achieve a high degree of reliability, b) at a low cost. This motivation is ultimately felt by the building owner, either directly (i.e., a motivation to contain the risk of roof damage), or indirectly (i.e., a motivation to contain the costs of insurance associated to the risk of roof damage).

Roof monitoring strategies can be implemented via skilled workers mandated to perform inspections of the roof and detect issues such as clogging of drainage passages before they lead to more significant issues such as roof damage. However, increasing costs associated to labor, issues pertaining to reliability of labor, health and safety considerations, and labor shortages, may make the cost of roof monitoring strategies implemented by skilled workers dissuasive, which may lead property owners to assume a greater risk of roof damage or a greater insurance cost.

### SUMMARY

Feasibility of performing a method of alerting a property manager of a roof pooling issue in a fully computerized/automated manner was assessed. Certain requirements were identified, and certain technical problems were encountered to meet these requirements. The main requirement was to be able to alert a property owner of a potential drainage issue on their roof in an automated manner, relatively quickly (e.g., within a small number of days), reliably, at a reasonable cost. It was found that one way of satisfying these requirements involves installing a digital camera with transmitting features on the roof of the property. The digital camera can be controlled by a controller, such as software functions executed by a processor of a local computer for instance, to automatically take pictures of the roof at certain times. The digital images can be stored in a non-transitory memory, such as one accessible to the processor of the computer for instance, in the form of image data. The image data may include the raw digital images, or data stemming from light, or heavy, software processing of the digital images. The image data can be associated to metadata such as, in particular, a timestamp. The roof-mounted hardware may need to be relatively autonomous and resistant to the elements. Integrating a solar panel and a battery to the roof-mounted system can help providing an autonomous power source. Moreover, the roof-mounted system can be provided with communication capabilities (e.g., wireless such as cellular or Wi-Fi) so as to be operable to transmit the image data to a remote computer, such as a cloud computing system, over a telecommunications network, such as the Internet.

The remote computer may have, e.g. in the form of instructions stored in non-transitory memory thereof, an image interpretation engine in the form of a trained engine, more specifically of the convolutional neural network (CNN) type (artificial intelligence), configured to detect the presence and/or absence of water pooling. The remote computer can further have an alert generator module configured to transmit an alert to the property owner when presence of water pooling is detected.

While this latter solution was satisfactory to a certain degree, there remained room for improvement. In particular, when sending an alert indicative of water pooling every time water pooling was detected in the image data, many of the alerts were not indicative of an potential issue, but rather of a normal occurrence of water pooling closely following a rainfall, or a “false positive”, erroneous detection of water pooling by the trained engine. Alerts sent every time water pooling is detected may thus be said to have a relatively low probability that an actual issue, i.e., one meriting manual investigation and/or remedy, is indeed occurring. Such low relevance alerts may come to be interpreted by a property manager as undesirable.

Indeed, not only does the automatic detection of the presence of water pooling by a well-selected and well-trained trained engine generate a certain amount of false positives such as traces of water pooling being interpreted by the trained engine as water pooling, but, it was found, a certain amount of water pooling is often normal and even expectable on flat roofs when significant precipitations occur, and are not necessarily indicative of a pooling issue (e.g., associated to a potential risk of damage to the roof). Indeed, flat roof drains may have a certain drainage flow rate limit, either inherently (e.g., by limits in the size of drain pipes, etc.) or intentionally (certain cities limit the allowed flow rate of rainwater to avoid overwhelming the city's rainwater drainage system capacities). Moreover, many flat roofs are not perfectly flat, and may have some areas which form shallow pools unassociated to drainage passages, and it may be expected that some amount of water pooling occur in those shallow pools until the water has time to evaporate.

The technological problem becomes: how to perform, in an automated manner, a differentiation, as efficiently as possible, between water pooling detections which are not indicative of an underlying issue, and water pooling detections which are associated to an underlying issue, i.e. such as may warrant the costs of a manual inspection or intervention. While it may not be possible to reach perfection, a goal may be to increase the reliability of any alert sent as being indeed indicative of an underlying issue while not “missing” the sending of an alert when an underlying issue is occurring, and sending alerts in a suitable timeframe. Indeed, if, to be 100% (or 99%) sure that an alert is indeed indicative of an underlying issue, the systems needs to take two weeks of time before sending an alert, such an alert, though reliable, may not be sufficiently timely to be useful, and may be considered as “old news”, and thus undesirable, by the property manager. It will be noted here that the technological environment in which this goal is to be achieved in an automated manner imposes certain limits and raises certain questions, such as how much information can be extracted from images of roofs. It was found that while careful optimization of the artificial intelligence solution used as the image interpretation engine was a key element on the road to achieving the goal, it was not sufficient, in and of itself, to achieve this goal since even a carefully optimized image interpretation engine, taken alone, led to a large number of undesirable alarms.

It was found that one technological solution to this relatively complex technological problem can involve the use of an alert filter module having a suitable configuration and/or suitable parameters, in combination with the image interpretation engine. More specifically, the alert filter module can be operable to use contextual data to classify the water pooling events detected by the image interpretation engine into two categories: i) alert-worthy events and ii) dismissed events. In this context, a good performance of the alert filter module can be measured by different parameters such as i) a high % accuracy of alert-worthy events being indeed indicative of an underlying issue, ii) a low % of dismissed events being in fact indicative of an underlying issue, iii) a limited amount of time between the occurrence of an underlying issue and the generation of an alert. There are different categories of contextual data which can be used in this manner, and depending on the embodiment, either one of these, or, in some cases, more than one in combination, may be used to achieve a targeted performance of the system as a whole.

A first one of these categories of contextual data is temporal consistency of the water pooling event detections by the image interpretation engine. In one example, timestamped water pooling events detected by the image interpretation engine are stored in a database. When a new water pooling event is detected by the image interpretation engine, the alert filter module determines whether a water pooling event was also detected at one or more preceding moments in time. This can involve the use of a contextual data retriever, for instance, which may, in this example, consult timestamped water pooling event data in the database. If no water pooling events were also detected at the one or more preceding moments in time (a determination that may be based, for instance, on the timestamps of the water pooling event data), the currently detected water pooling event may be considered “recent”, and categorized as a dismissed event, in which case no alert is sent to the user by the alert generator module. If, instead, a water pooling event is indeed detected at the one or more preceding moment in time (e.g., on the preceding day), the currently detected water pooling event may be considered “sustained”, and thus classified as a potential pooling issue, in which case an alert may be sent to the user by the alert generator module. The details of the “one or more preceding moments in time” can be parameters of the alert filter module, and values of which may vary from one embodiment to another based on user preferences, known features of the roof, and/or historical weather patterns for the given locality, for instance, in a fine-tuning effort to optimize the rate of “true alerts” sent in a reasonable amount of time while minimizing the rate of “false positives”.

A second one of these categories of contextual data is weather data. In one example, when the image interpretation engine detects a water pooling event, the alert filter module determines whether the pooling event is tied to “recent” precipitations. This can involve the use of a contextual data retriever, for instance, which may, in this example, consult weather data which may be in the form of current weather data or historical weather data for instance. The weather data may be acquired a weather station, such as via the Internet for instance, or from weather sensors integrated to the roof-mounted system for instance and can be indicative of the weather in the locality of the camera where the image data is acquired. In some cases, more than one source of weather data may be available, different sources of weather data may be taken into consideration by the contextual data retriever, and a reliability factor of the different sources of weather data may be taken into consideration in giving more or less weight to individual ones of the sources in the determination. If the weather data indicates that precipitations (possibly of a certain set minimum value) have occurred in a given period of time preceding the image acquisition, or during the image acquisition, the alert filter module may classify the water pooling event as a dismissed event, in which case no alert is sent to the user, and alerts only be sent to the user when water pooling is detected when no precipitations are detected within the corresponding timeframe.

There are other categories of contextual data, another one of which can be tied to other optional determinations which may be made by the image interpretation engine. For instance, the image interpretation engine may have a function to determine the presence of water pooling, a function to determine an absence of water pooling, a function to determine a presence of a drain, and a function to determine the presence of debris. By consulting determination history, the alert filter module may, for instance, determine that a) a drain was detected in a large number of the images in the past, b) debris was detected in one or more recent images, and c) water pooling is detected. In such a context, the detection of water pooling may be given more weight, given the detections of the drain and of debris possibly blocking the drain, than a water pooling detection would be given absent such additional detections, and may thus lead to sending an alert to the user sooner than an alert would otherwise have been sent.

In some cases, contextual data from more than one category may be combined in a manner to further optimize the rate of “true alerts” and minimize the rate of “false positives”. For instance, temporal consistency of the water pooling detections can be combined with the use of weather data in an effort to achieve desired performance.

In accordance with one aspect, there is provided a computer-implemented method of alerting a property manager of a pooling issue pertaining to a roof of a building, the method comprising: providing image data including an image of the roof of the building; determining that water pooling is present in the image the roof of the building, including processing the image of the roof of the building using a trained convolutional neural network; providing contextual data pertaining to at least one of weather, history, and drain obstruction associated to the determined water pooling; determining that the determined water pooling is indicative of the pooling issue, including validating a contextual criteria against the contextual data; and transmitting an alert to the property manager contingent upon said determining that the determined water pooling is indicative of the pooling issue.

In accordance with one aspect, there is provided a computer-implemented method of alerting a property manager of a pooling issue pertaining to a roof of a building, the method comprising: providing image data including an image of the roof of the building; determining that water pooling is present in the image the roof of the building, including processing the image of the roof of the building; providing contextual data pertaining to at least one of weather, history, and drain obstruction associated to the determined water pooling; determining that the determined water pooling is indicative of the pooling issue, including validating a contextual criteria against the contextual data; and transmitting an alert to the property manager contingent upon said determining that the determined water pooling is indicative of the pooling issue.

In accordance with one aspect, there is provided a computer-implemented method of alerting a property manager of a pooling issue pertaining to a roof of a building, the method comprising: providing image data including an image of the roof of the building; determining that water pooling is present in the image the roof of the building, including processing the image of the roof of the building using a trained convolutional neural network; providing contextual data; determining that the determined water pooling is indicative of the pooling issue, including validating a contextual criteria against the contextual data; and transmitting an alert to the property manager contingent upon said determining that the determined water pooling is indicative of the pooling issue.

In accordance with one aspect, there is provided a computer-implemented method of determining a pooling issue pertaining to a roof of a building, the method comprising: providing image data including an image of the roof of the building; determining that water pooling is present in the image the roof of the building, including processing the image of the roof of the building using a trained convolutional neural network; providing contextual data pertaining to at least one of weather, history, and drain obstruction associated to the determined water pooling; and determining that the determined water pooling is indicative of the pooling issue, including validating a contextual criteria against the contextual data.

In accordance with one aspect, there is provided a computer-implemented method of determining a pooling issue pertaining to a roof of a building, the method comprising: providing image data including an image of the roof of the building; determining that water pooling is present in the image the roof of the building, including processing the image of the roof of the building; providing contextual data; and determining that the determined water pooling is indicative of the pooling issue, including validating a contextual criteria against the contextual data.

Many further features and combinations thereof concerning the present improvements will appear to those skilled in the art following a reading of the instant disclosure.

### DESCRIPTION OF THE FIGURES

In the figures,

FIG. 1 is a schematic view of an example of a system for alerting a property manager of a roof pooling issue, in accordance with an embodiment;

FIG. 2 is a flowchart of an example method of alerting a property manager of a roof pooling issue, in accordance with an embodiment;

FIGS. 3 to 5 are graphs presenting performance indicators pertaining to different scenarios;

FIGS. 6A to 6D are example of digital images of roofs of buildings showing different possible scenarios;

FIG. 7 is a flow chart of an example embodiment of an example method of determining a roof pooling issue; and

FIG. 8 is a flow chart of an example image analysis subprocess;

FIG. 9 is a flow chart of an example weather data analysis subprocess;

FIG. 10 is a flow chart of an example search prediction history subprocess;

FIG. 11 is a flow chart of an example alert decision subprocess;

FIG. 12 is a flow chart of an example filtering subprocess; and

FIG. 13 is a block diagram of an example computer.

### DETAILED DESCRIPTION

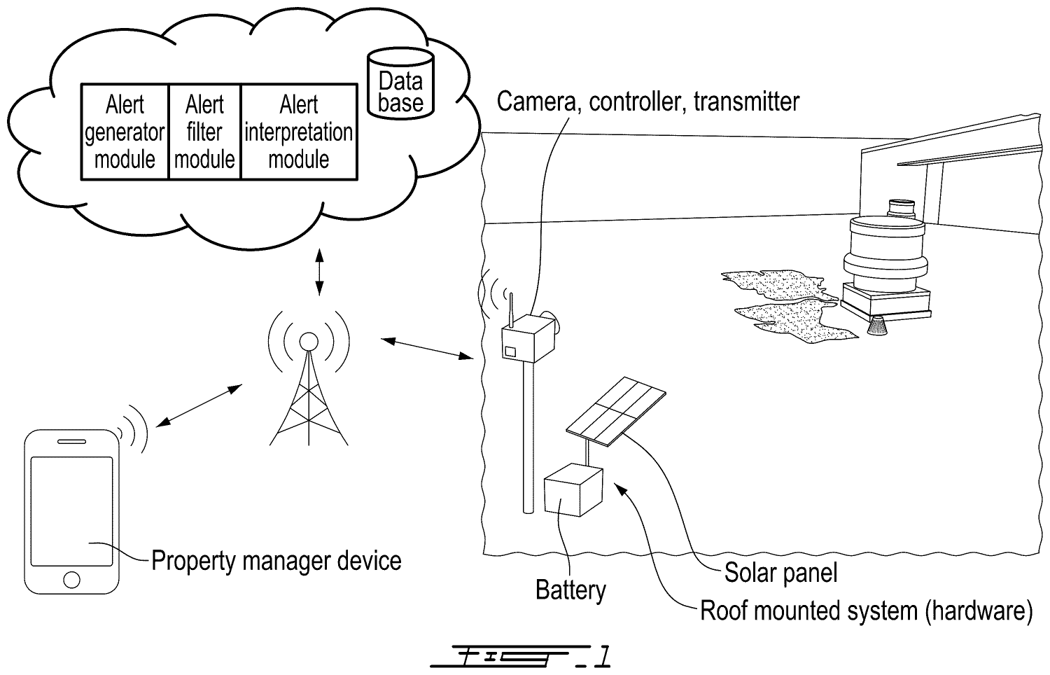

FIG. 1 shows an example of a system for alerting a property manager of a roof pooling issue. In this example, the system includes several pieces of hardware at various locations, including: a roof mounted system, a telecommunications network, a cloud-based computer system, and a property manager device. The roof-mounted system includes hardware physically located at the roof of the building. The cloud-based computer system is located at premises remote from the roof of the building. The property manager device may be located in the building, at a monitoring facility, or carried on the person of a property manager for instance. In practice, the functions performed by the cloud-based computer system are typically shared between a plurality of different roofs of different buildings, each one of which have a corresponding roof-mounted system, different ones of which may be managed by a same, or different property managers.

The roof mounted system can have a camera configured to acquire digital images, a controller (e.g., software functions of a local computer), and a transmitter and be operable to transmit the digital images to the cloud-based computer system over the telecommunications network, either in a raw format or in a pre-processed format. The digital images can be timestamped.

The cloud-based computer system is located at premises remote from the roof of the building. The expression “cloud” refers to the feature that these computing functionalities may be leased and while typically located in a same country than the roof of the building, the exact physical locality of its hardware elements may be undisclosed to the users of its computing functionalities. The computing functionalities may include three general functions, which will be referred to as engines or modules herein for simplicity: an image interpretation engine, an alert filter module, and an alert generator module. A database in the form of cloud data storage may also be provided by the cloud-based computer system.

The property manager device may have application specific software pertaining to the alert functionality or to the possibility of accessing data pertaining to the roof of the building in the database, or may entirely passively receive the alerts such as via SMS or email, to name some examples.

A service provider of the computer-implemented method of alerting property managers of pooling issues pertaining to roofs of respective buildings may provide one or more of the roof-mounted system, the cloud-based computing functions, and possibly application specific software installed on the property manager device, for instance. The property manager device may be a property of the property manager. The cloud-based computing functions may be executed by a cloud-based computer system made available to the service provider of the computer-implemented method of alerting property managers of pooling issues pertaining to roofs of respective buildings by a cloud service provider such as Amazon Web Services (AWS). It will be noted that cloud service providers use specialized processors to achieve suitable performances when running machine learning processes such as CNNs. Such specialized processors include graphics processing units (GPUs) such as manufactured by Nvidia. Indeed, as of a report dated May 2023, Nvidia had 95% of the market for machine learning GPUs. Such AI chips were sold roughly 10 000$ each around the same period.

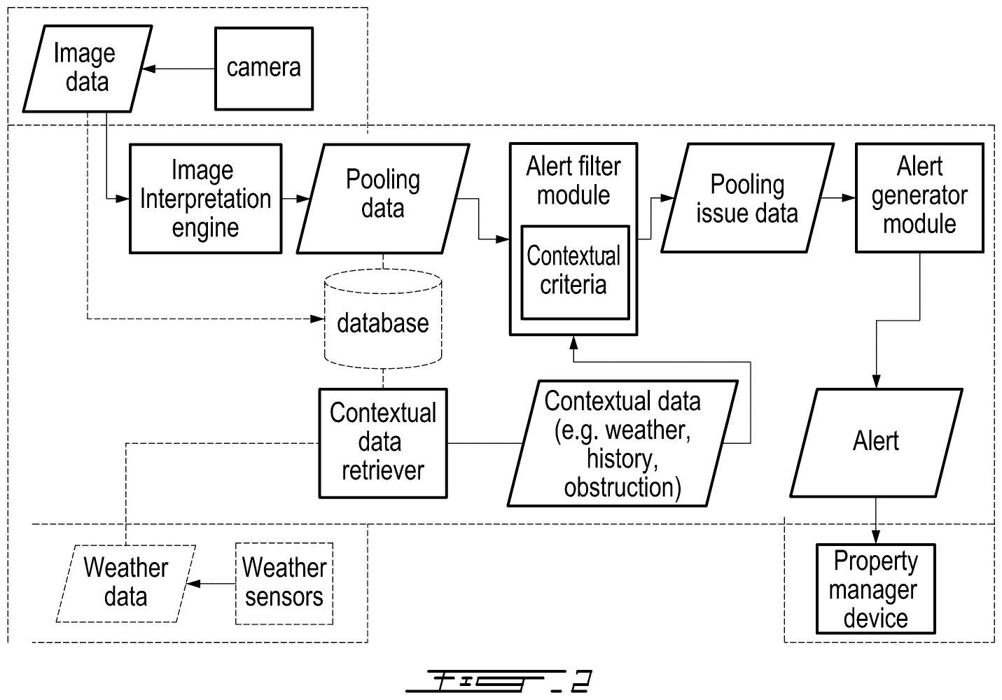

Turning now to FIG. 2, an example of a computer-implemented method of alerting a property manager of a pooling issue pertaining to a roof of a building will now be described. A camera, such as a digital camera which may be integrated to a roof-mounted system, can generate image data. The image data can include one or more digital images of the roof of the building, such as different digital images of the same roof of the building taken at different moments in time. The digital images may either be provided in raw format as acquired directly from the digital camera, or pre-processed (e.g., compressed). The image data can include metadata associated to different ones of the digital images. For instance, the metadata can include a timestamp which may allow the cloud-based computing functions to identify a moment in time, with a relative degree of precision, at which each digital image was taken.

A software functionality which will be referred to herein as an image interpretation engine for ease of reference, is responsible for performing a computer-implemented process of determining whether water pooling is present or not. In practice, the image interpretation engine can be implemented by the convolution neural network (CNN) technology. From the point of view of the water pooling determination functionality, the CNN technology involves a training mode during which the CNN is “trained” by being subjected to images in which pooling is identified as present and images in which pooling is identified as absent. The presence or absence of water pooling in such images may have been previously determined by humans, for instance. Once the training mode is complete, the CNN can be subjected to new images and provide a determination, commonly referred to as a “prediction”, of how likely it is that water pooling is present or absent in the new image. Greater performance may be achievable by subjecting the CNN to training on a larger data set, a data set having a greater accuracy of classification, and/or by choosing a type of training which may be better adapted to the desired output, and more about this will be provided below. The output of the CNN prediction is typically a % value of how likely the CNN considers the presence of water pooling as present. This % value can be converted into a binary value such as “water pooling=present” or “water pooling=absent” by setting a threshold value, and classifying the water pooling as present when the % value is above or equal to the threshold value, and classifying the water pooling as absent when the % value is below the threshold value, for instance. In practice, a different CNN process (including different training phase) may be used to determine the presence of water pooling and to determine the absence of water pooling, and when processes are used, a higher degree of confidence of the presence or absence of water pooling may be achieved by cross-referencing the output of the process which determines the presence of water pooling and the process which determines the absence of water pooling.

The output of the water pooling determination function of the image interpretation engine will be referred to as pooling data. The pooling data may include only situations where water pooling was positively identified in the image by the image interpretation engine, but in practice, it can be more convenient to store all the details of the image interpretation engine in a database, including not only the cases where water pooling was positively identified, but also the cases where the water pooling was identified as absent, and possibly including details such as the % value outputted by one or more relevant process of the image interpretation engine, the threshold value(s) which were applied, etc. In some cases, it can be preferred to store all these elements of data as additional metadata associated to different ones of the digital images, all in the same database, in a manner to allow later retrieval of all relevant data for purposes such as troubleshooting or diagnostic.

A software functionality which will be referred to herein as an alert filter module for ease of reference, is responsible for performing a computer-implemented process of determining whether occurrences of water pooling determined by the image interpretation are likely or unlikely to be indicative of a pooling issue, e.g., whether the detected situation warrants alerting a property manager to trigger a costly manual inspection process on the roof or not. The alert filter module can perform this determination by validating a contextual criteria against contextual data. The contextual data may pertain to one or more of weather, history, and obstruction associated to the determined water pooling occurrence, for instance. Some more detailed examples will be provided below, but two first examples will now be presented for illustrative purposes. In a first example, for instance, the contextual data may pertain to weather at the time the digital image which is at the source of the determination of water pooling was taken, or during a period of time preceding that time. For instance, in the first example, the contextual criteria may be to determine that there was no rain for two days preceding the time at which the digital image was taken, and this contextual criteria may be validated against weather history data pertaining to the weather at the locality of the roof of the building. In the second example, for instance, the contextual data may pertain to history of the determinations, and while a determination of water pooling in one digital image, in and of itself, may not be associated to a likelihood of a pooling issue, determining that the water pooling was also detected in earlier digital images of the same roof may be associated to a higher likelihood of a pooling issue. Indeed, while pooling may occur due to rain, it may usually be expected to drain over a relatively short period of time and a history of determinations of water pooling spanning a relatively longer period of time may be more likely to be associated to a pooling issue. In such a second example, the contextual criteria may be to have determined a water pooling in most (e.g. above a threshold %) of the digital images within a certain timeframe preceding the current determination of water pooling for the current determination of water pooling to raise a determination of a water pooling issue. In some embodiments, more than one category of contextual data may be used in a cross-referenced manner. For instance, a pooling issue may be determined to be present if a) water pooling is determined to have been detected in most of the digital images within a certain timeframe preceding the current determination of water pooling and b) no rain has been indicated at the locality of the roof by the weather history (e.g., not more than 5 mm or rain) within a certain timeframe preceding the current determination of water pooling.

A software functionality which will be referred to as the contextual data retriever module can be responsible for retrieving the contextual data, such as interrogating weather stations about detected weather conditions, possibly storing the detected weather condition history in a database, or simply interrogating an external weather history database for instance. In some cases, the roof-mounted system can include one or more weather sensor which can generate weather data, and the weather data may be used alone, or in combination with additional weather data as may have been collected from third-party weather stations, as contextual data.

The output of the alert filter module can be referred to as pooling issue data. The pooling issue data may, in some cases, include only the positively determined occurrences of pooling issues, though in some other embodiments, it may be deemed preferable to include not only the positive determinations but also the negative determinations, and optionally further detail about the contextual criteria and associated contextual data which were used to make the determination, and to store the pooling issue data in a database, possibly as part of the metadata associated to the corresponding digital images.

A software functionality which will be referred to herein as the alert generator module can be responsible for transmitting the alert when a pooling issue is determined to be present by the alert filter module.

### Example Embodiments

It will be understood that while the alert filter module can help in increasing the relevance of determinations of water pooling made by the image interpretation engine to be used as indications of pooling issues in the context where pooling issues are used as a trigger to send alerts to a property manager, the performance of the overall system will typically be better when the performance of the image interpretation engine is better. Therefore, one may want to improve the performance of the image interpretation engine as much as possible. In one example, the CNN forming part of the image interpretation engine was trained using the transfer training technique. In the context of the transfer training technique, a CNN which had already been trained to determine the presence or absence of other things in digital images forms the basis of the training. The final layer of the CNN is reconfigured to allow it to detect new things. In the context of transfer training, the CNN is also allowed a degree of freedom to change its parameters (i.e., not only learn, but also, to a certain extent, unlearn) in other layers to achieve greater performance for its new task, as opposed to “fine tuning” techniques where only the final layer of the CNN is changed.

In this example embodiment, the CNN (AI vision model) was trained on several thousands of human labelled pictures of roof with and without pooling in order to train the model to detect the characteristics. The trained model is proficient at detecting pooling water with an F1 Score of 86% which demonstrates a balanced combination of precision and recall (Sensitivity). This score is a harmonic mean of the two, providing an overall measure of the model's ability to accurately identify pooling water. An accuracy of 84% reflects the overall correctness of the model's predictions and the lower value (14%) of False Discovery Rate (FDR) indicates suggests that the model generally avoids making false claims about the presence of pooling water. More specifically, the CNN AI Model metrics achieved in this example are as presented in table 1 below:

TABLE 1
Vision AI (CNN) Model Metrics

| | |
|---|---|
| Sensitivity (Recall, TPR) | 0.8528 |
| Specificity | 0.8126 |
| Precision | 0.8605 |
| Negative Predictive | 0.8028 |
| Value | |
| False Positive Rate | 0.1874 |
| False Discovery Rate | 0.1395 |
| False Negative Rate | 0.1472 |
| Accuracy | 0.8357 |
| F1 Score | 0.8566 |

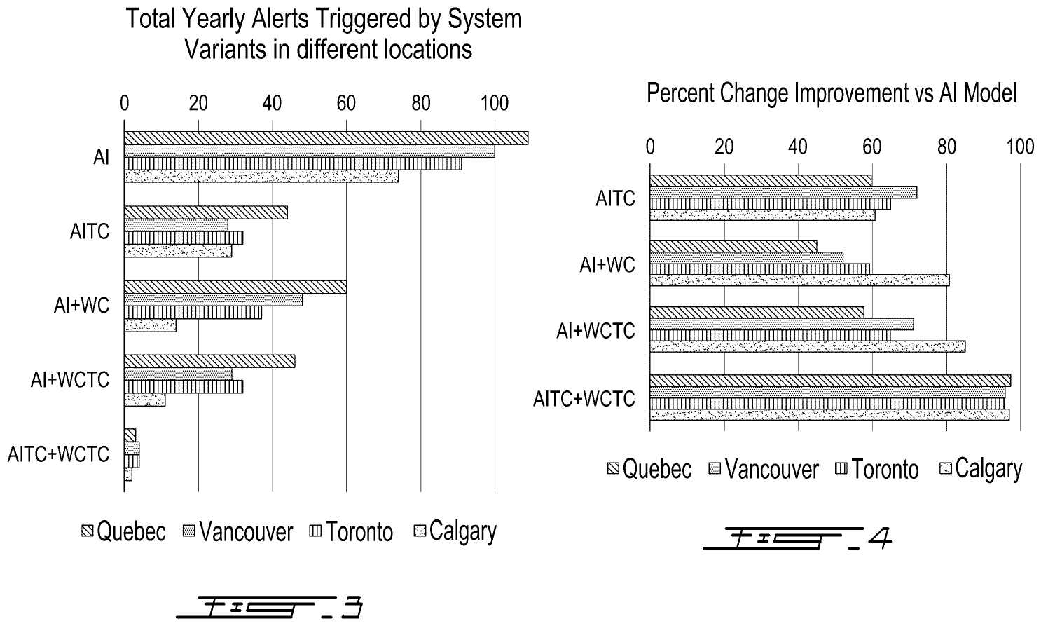

In a first scenario, referred to in the graph presented in FIG. 3 as AI, an alert is sent to the property manager each time the image interpretation engine (more specifically the CNN) makes a determination that water pooling is present in the digital image. The first scenario is presented for the actual weather history of 4 Canadian cities, Quebec, Vancouver, Toronto and Calgary, over the entire 2022 year. In this first scenario, a determination of whether water pooling is present or not is performed by the image interpretation engine once per day. It will be noted here that the frequency of the determination can vary depending on the embodiment and can be different in other embodiments.

Although this implementation succeeds at detecting water pooling at a relatively high degree of confidence, basing the sending of alerts to property managers based solely on the detection of water pooling proves to be problematic in real-life scenarios. While a AI model, even with flawless performance, excels at recognizing patterns, relying solely on it ends up inundating recipients with false alarms. This variant would generate on average 94 alerts per year with a false discovery rate of 98% (or an alert every four days), requiring an operator to review and suppress it most of the time. Post-hoc analysis revealed that pictures taken remotely offer a limited and static view of the roof, lacking crucial context and dynamic factors that influence water pooling problems. For instance, a picture might not capture recent weather conditions that could have contributed to temporary pooling. Additionally, photographs might not reveal hidden obstructions like debris or leaves blocking drains that affect water flow if they are submerged. As the AI model predominantly detects the presence of water without considering contextual factors, its inherent capability to differentiate between problematic and non-problematic scenarios is limited, resulting in a superficial understanding, and potentially leading to costly mistakes or unnecessary actions. FIG. 3 shows the number of alerts generated yearly in each location based on the different characteristics used in the decision process.

A second scenario, referred to in the graph presented in FIG. 4 as AITC, a first example functionality of an alert filter module is implemented, and the alert is sent to the user only if the alert filter module determines a pooling issue associated to the determination of water pooling. In this second scenario, more specifically, the contextual criteria for the alert filter module is that pooling has been determined by the image interpretation engine at least twice over the last three days (still in a specific context of one determination per day). As can be seen, in this second scenario (labeled AITC), the number of alerts sent to the property manager is significantly lower than in the first scenario (labeled AI). The amount of “false alerts” is thus significantly less, while the process can still allow to send an alert to the property manager in a reasonable amount of time (e.g., 3 days in this case). This process also allows to reduce the amount of false positives which may stem from an incorrect determination of water pooling made by the CNN.

In a third scenario, referred to in the graph presented in FIG. 4 as AI+WC, considers recent weather data that are available and correlates them with the determination of water pooling made by the CNN. If a pooling determination occurs shortly after or during heavy rainfall, it might be temporary. However, if the problem is detected during dry weather, there might be a more systemic issue. Introducing the weather correlation (WC) component, the third scenario leverages historical weather data to complement the CNN's determinations. This variant is referred to as “Weather Correlated (AI+WC)” and is implemented in such way that alerts are only delivered when pooling water is detected by the CNN but the amount of precipitation doesn't exceed a configurable threshold. It is generally safe to say that in common conditions, it requires over 5 mm of daily precipitation to generate pooling, as lower amounts of precipitation is often naturally managed by the drainage system, and therefore, in this case, the configurable threshold was set to 5 mm.

As shown in FIG. 4, an average a 59% improvement can be achieved between the third scenario (AI+WC) and the first scenario (AI) in reducing the number of alerts when correlating weather data. By analyzing the correlation between weather patterns and pooling predictions, this approach mitigates the occurrence of false positives. Consequently, this variant effectively addresses some false positives, and more specifically leads to a decreased false detection rate of 3% in this specific embodiment.

While this approach is valuable for contextualizing the presence of pooling water in relation to recent weather events, it has certain limitations. As it focuses on immediate weather conditions, it may lead to an oversight when it comes to prolonged rainfall over multiple days. If an area experiences consistent rain for an extended period, the system doesn't always effectively capture this continuous weather pattern. As a result, it sometimes doesn't adequately account for the cumulative effect of days of rain, leading to false negatives or conversely, generate a false alert after a lull in the rain even though the rain has not yet finished falling and the water accumulation detected is normal. In addition, urban drainage systems often include flow limiting characteristics to manage water flow and prevent flooding of the sewage system during prolongated or heavy rain. These characteristics, such as flow restrictors or controlled release mechanisms, are designed to control the rate at which water is discharged. Without further customization, the Weather Correlated approach may not consider these urban drainage system features, potentially leading to false alarms or misinterpretation of pooling water as a problem when it's a part of the controlled drainage process.

A fourth scenario is labeled AI+WCTC in the graphs of FIGS. 3 and 4. In this fourth scenario, to improve the system's accuracy and reliability in scenarios of continuous or semi-continuous rain over several days, historical weather data in conjunction with temporal consistency filtering, are integrated in the system. Temporal consistency refers to the degree of continuity, stability, or regularity in patterns over time. In the context of the roof water pooling detection system, weather correlated temporal consistency (WCTC) involves assessing whether the weather correlation remain consistent over consecutive time periods. This variant referred to as “Weather Correlated Temporal Consistency (AI+WCTC)” examines the persistence of the weather conditions over consecutive time periods before correlating with the CNN determination of water pooling. The system maintains a record weather data for each location, compares the current prediction with the historical weather data to determine if the issue persists or is transient and alerts are generated only when pooling is present and the weather correlation consistent over time, indicating a higher likelihood of a true positive. This helps differentiate true positive cases from temporary factors or anomalies. For example, in a scenario where the rain faded briefly between days and therefore the amount of precipitation was lower than the set threshold during the current day for the system to detect that it was still raining enough to prevent the pooling to completely disappear, the “Weather Correlated” variant would have sent an alert, but the new approach, which analyzes the continuity of correlated precipitation data according to a sliding time window, prevents the alert from being sent. Moreover, this approach aligns the AI model more closely with the initial objective of the roof inspector, who has a memory, albeit less precise, of the local weather history. Results with this variant show on average a 70% improvement in comparison with the first scenario (labeled AI in FIG. 3), thus further discerning true positives from transient factors. The demonstrated reduction in the number of alerts, as shown in the data, reflects the efficiency of this variant in curbing false positives and achieving on average a 4% lower false detection rate.

A firth scenario, labeled AITC+WCTC in FIGS. 3 and 4, is also represented. In this fifth scenario, not only is the CNN determination cross-correlated temporally-consistent weather data, but the temporal consistency concept is can also be applied to the CNN determination as evoked above in relation with AITC. Similar steps are made to implement this feature in this context: the system maintains a record of previous model predictions for each location, it compares the current prediction with the historical predictions to determine if the issue persists or is transient and alerts are generated only when predictions exhibit consistent patterns over time, indicating a higher likelihood of a true positive. However, intuitively running the CNN determinations over multiple days and using historical results, even if the CNN determinations has good accuracy and precision, can lead to a decrease in overall accuracy over time due to the error propagation phenomenon if the joint probability of each historical prediction is calculated and used to determine whether the alert should be sent. Since each run is independent, the probability of error in each run is multiplied and so higher is the chance that errors will add up multiplicatively, reducing the overall reliability of the system. This may make the use of AI with temporal consistency unsuitable for some embodiments. In this scenario, the rate of error of the CNN is taken into consideration in the setting of a metric as the threshold for sending an alert. The choice of historical time range to consider will determine how quickly we can send an alert after the AI has detected the problem. The threshold is chosen according to the performance of the AI model and our tolerance of the risk of sending an alert unnecessarily. For example, to ensure that an alert is sent at the latest on the third day that the problem is present, we could set the system so that if a problem has been detected at least two times in the last three days, an alert is sent. It is, of course, possible to maintain the use of the model's confidence level in conjunction with this approach. This approach is a compromise between speed and accuracy of alerts. Performance-wise, it's similar to AI combined with weather data (AI+WC), but can be better or worse depending on the parameters and the local weather, as successive days of rain can still raise alerts unnecessarily. For this reason, AI with Temporal consistency may not always be adapted to be used on its own and may benefit from being done in conjunction with the weather data in the implementation to mitigate this issue, otherwise errors may simply be propagated, potentially negating the otherwise positive tradeoff.

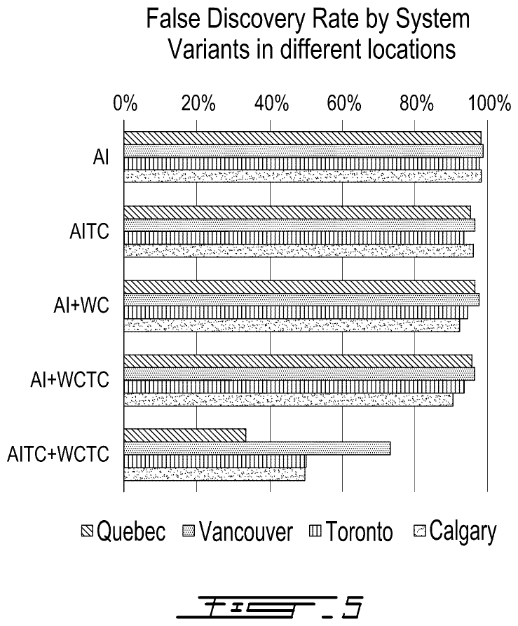

In this fifth scenario “(AITC+WCTC)” temporal consistency in AI predictions is combined to temporal consistency in weather correlation. In concrete terms, this method ensures constant water accumulation during and, more importantly, after the rainy period, even though the conditions required for the roof to dry out were present. Through a dual approach that evaluates the coherence of both predictions and weather patterns over time, this variant excels at minimizing false positives, a reduction in false discovery rate of 47% in average compared to AI alone as presented in FIG. 5. The data provided affirms the effectiveness of this approach, as evidenced by the 96.5% decrease in the number of alerts and the lowest false detection rate across all variants. This variant ensures that the pooling was visible during a period long enough for it to be problematic while filtering cases where it was simply due to long lasting weather phenomenon.

An example embodiment of a process of alerting a property manager of a roof pooling issue will now be described. In this example, the image interpretation engine which is CNN-based makes a number of parallel determinations pertaining to each roof image. A first one of these CNNs processes the digital image to make a determination of the presence of a drainage system, another one of these CNNs processes the digital image for the presence of pooling water. Another one of these CNNs processes the digital image for the presence of traces of pooling. Another one of these CNNs processes the digital image for the presence of debris. Still other CNN processes can run in parallel for the detection of other elements. The determinations of all the CNN processes can be recorded as part of the metadata associated to each one of the digital images. Furthermore, the system leverages real-time weather data, obtained from both the device and nearby weather stations, to determine if pooling water on the roof is merely a result of precipitation or a more critical problem requiring immediate attention. By analyzing the duration of pooling water and evaluating the presence of blocked drains, debris, and other defects, the algorithm assists in accurately assessing the severity of the situation. This innovative technology provides proactive roof maintenance and management, reducing potential damage, and increasing the lifespan of roofs. The system can detect water pooling and related problems. It can capture and process images, apply image analysis algorithms, consider historical data, integrate weather information, and generate alerts when necessary. By following a systematic approach, the system can help timely identification and resolution of pooling and drainage issues, helping to mitigate potential damage and ensure effective maintenance.

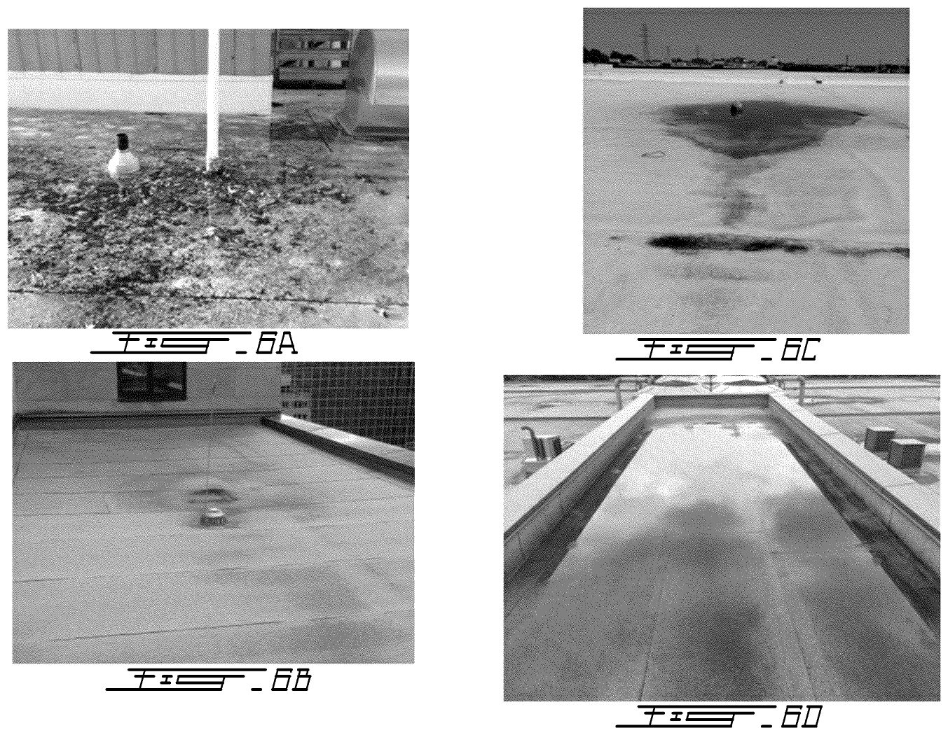

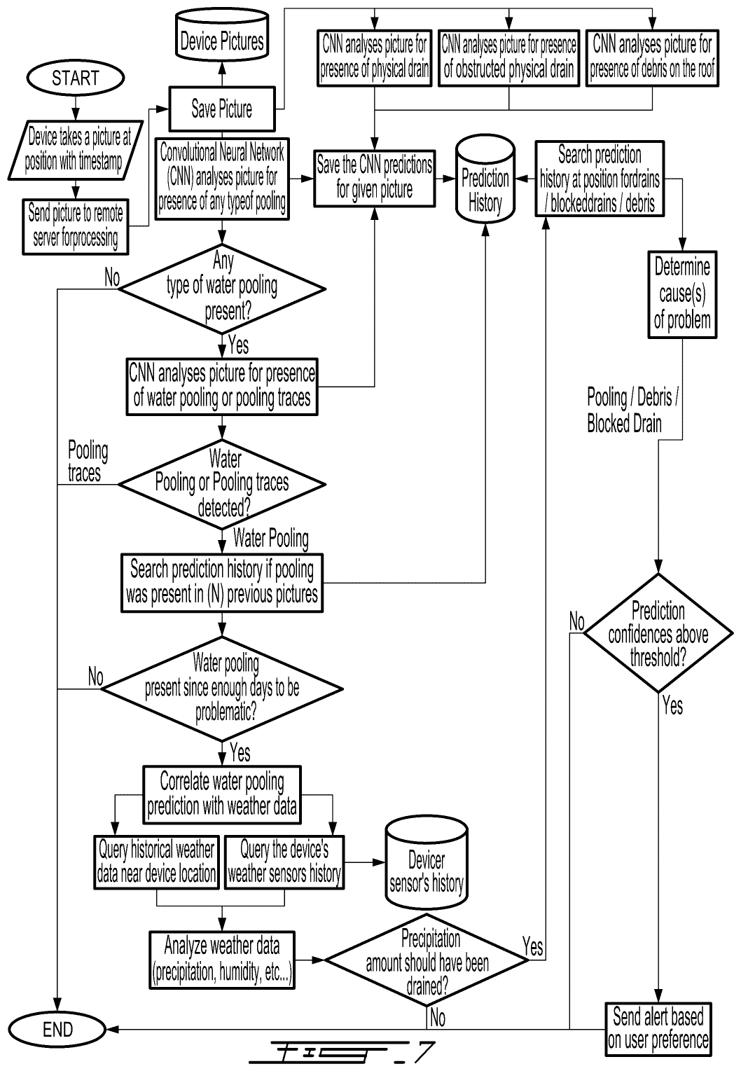

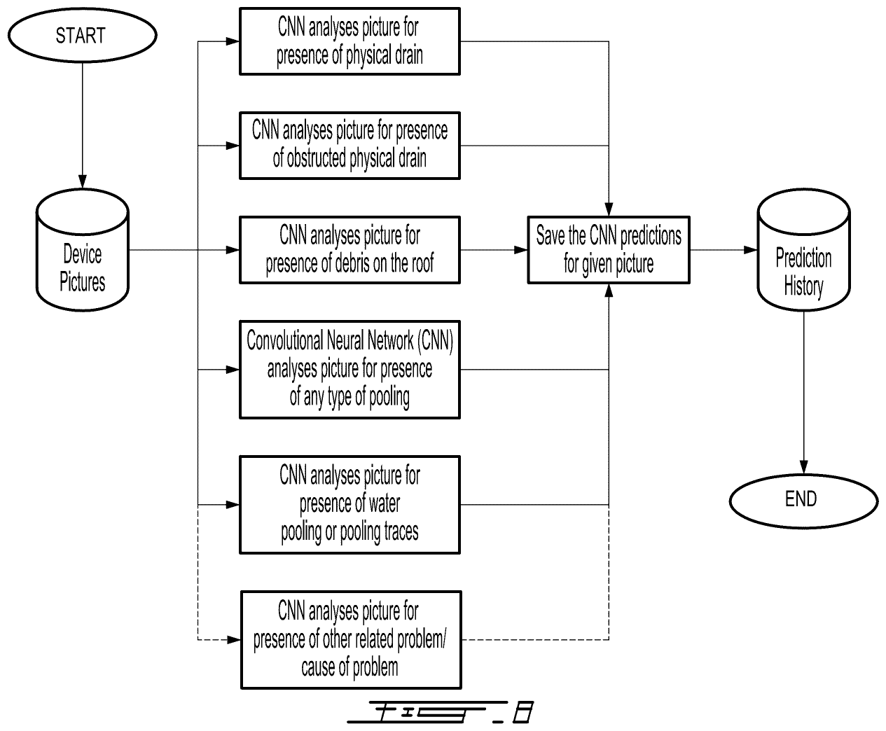

FIGS. 6A, 6B, 6C and 6D all present examples of images which may be acquired from roofs of buildings, illustrating different conditions. In FIG. 6A, the image shows a section of a roof with scattered debris, such as leaves and branches. The presence of debris can potentially obstruct the drainage system, leading to water pooling. In FIG. 6B, the image shows a functional drain. The drain appears dirty but unobstructed, facilitating proper water flow and preventing pooling. In FIG. 6C, the image shows significant amount of water pooling on the roof surface. The pooling is evidenced by the accumulation of rainwater, highlighting a potential drainage issue. Pooling traces are also apparent, showing dark dirt spot on the roof highlighting the problem. In FIG. 6D, the image shows pooling water without a visible drain. It could be right after the rain stopped, and not enough time was given for the water to evaporate or drain. This emphasizes the importance of utilizing weather data in solving the technical problem, ensuring that the system can accurately distinguish between temporary situations and persistent drainage problems, leading to more effective and targeted interventions.

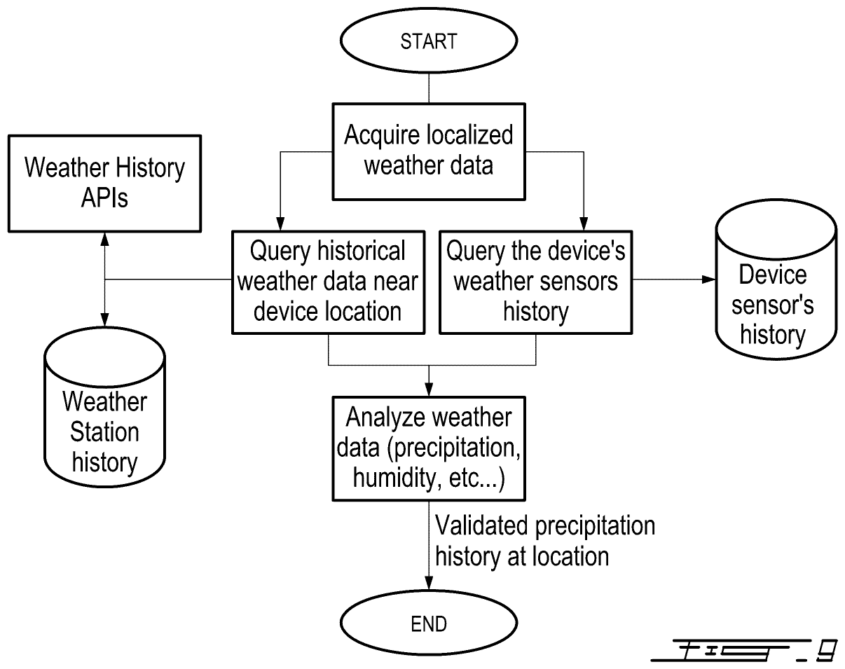

The flowchart represented in FIG. 7 is a system for analyzing pictures taken by a device to detect water pooling and potential drainage issues. The system begins by capturing a picture at a specific position with a timestamp and saving it. Simultaneously, the picture is sent to a remote server for processing. A Convolutional Neural Network (CNN) analyzes the picture for the presence of any type of pooling. In parallel, the system further analyzes potential causes such as the presence or absence of physical drains, debris on the roof, or obstructed physical drains.

Once the analysis is complete, it saves the CNN predictions for the given picture in the prediction history. If pooling is detected, it identifies if it is water pooling or other types of pooling. If it is water pooling and not only pooling traces, the system checks if pooling was present in previous pictures and if historical pooling instances are found. If they do, the water pooling prediction is correlated with weather data obtained from the device and nearby weather stations. This involves querying historical weather data near the device's location and analyzing factors such as precipitation, humidity, etc., as well as querying the device's weather sensor history.

Based on the analysis of weather data, the system determines if the pooling water has been present for a sufficient duration to be considered problematic. It then analyzes the weather data further to determine if the precipitation amount should have been drained.

After analyzing the picture for causes, the system searches the prediction history at the position for information on drains, blocked drains, or debris. It determines the cause of the identified problem.

Next, the system checks if the prediction confidences for the current picture exceed a parameterized threshold. Finally, an alert is sent based on user preferences, indicating the presence of pooling and potential drainage issues. The system also supports other problem detection in a more proactive manner, in order to be able to send alerts of upcoming risk of problems such as the presence of debris that could migrate and settle at the intake or in the drainage pipe.

The system goes beyond traditional image analysis techniques and introduces a new concept of combining environmental factors with visual observations to detect and evaluate problems. It acknowledges the challenge of false positive alerts stemming from factors such as weather patterns and roof characteristics. To address this issue, the proposed system introduces a novel approach that correlates weather data, previous model predictions, and employs temporal consistency filtering. It requires the integration of image processing algorithms, data retrieval mechanisms, and analytical techniques for weather-related factors.

The correlation with weather data and duration assessment significantly improves the accuracy and reliability of problem detection. By considering weather conditions, such as precipitation and humidity, in conjunction with the pooling observations, the system gains a comprehensive understanding of the situation. This evidence can be crucial for various purposes, including maintenance planning, historical analysis, and dispute resolution. It enables the system to establish a factual basis for alert generation and facilitates effective decision-making based on objective information. This technical effect enhances the overall performance and efficiency of the system, resulting in more precise and meaningful alerts. Simply relying on visual analysis of pictures may not provide a complete understanding of the problem's severity or underlying causes. By incorporating weather data and duration assessment, the system overcomes these limitations and enables a more comprehensive approach.

Water pooling is highly dependent on weather conditions, especially precipitation. During periods of heavy rain, pooling may naturally occur as the drainage system becomes overwhelmed. However, this pooling is temporary and expected until the rain subsides, allowing the drain to evacuate the water or for evaporation to take place. Without considering the weather context, detecting pooling water alone would not differentiate between a temporary situation and an actual drainage problem. For example, if the system were to detect pooling during heavy rainfall but fails to recognize the transient nature of the issue, it may generate false positive alerts and lead to unnecessary maintenance or interventions. By incorporating weather data, the system can differentiate between expected pooling during rain events and situations that require attention.

Analyzing the duration of pooling events and correlating them with weather data enables historical analysis and trend identification. By comparing the occurrence of pooling with specific weather patterns over time, the system can identify recurring issues, drainage inefficiencies, or other related factors. This historical perspective helps in evaluating the overall performance of the drainage system and supports proactive maintenance and problem prevention. The FIG. 7 exposes the general process used in the system, however in a real implementation of the system based on the figure, some steps could be reordered or parallelized in order to improve performance, throughput and responsiveness while maintaining accuracy. The exact nature of the problem detection algorithm is also bound to evolve along with new computer vision methods, and is not limited to CNNs despite the fact that this class of algorithm is cited as an example.

To illustrate the system's capability in detecting and analyzing various scenarios related to water pooling and drainage issues, we present a table containing example pictures showcasing different situations. Each picture represents a specific condition, such as debris, drains, pooling water, blocked drains, and blocked drains with pooling water.

The system explained previously and illustrated in the FIG. 7 is one embodiment of the different processes and sub-process allowing the detection of rooftop irregularities. This process could be divided further in separate entities, which could be arranged in a different fashion, parallelized, centralized, or distributed. In the following sections, work is done to further subdivide this generic process into independent work units.

The essence of the proposed system revolves around the correlation between problems detected from roof images and external data. A step is therefore to acquire the necessary images of the roof in an automated fashion. The method once triggered proceeds to acquire a input, where the device captures an image at a specific position and time. The captured image is then sent to a remote server for processing. If requirements permit, the image can also be saved and/or processed on site. The processed image is saved and stored in a storage system such as a database, for example. Finally, the method terminates once the system has confirmation that the picture is saved. The flowchart provides a clear and concise representation of the method, which can be used to implement the invention in various scenarios. Note that the database storage illustrated by “Device Pictures” is reused multiple times in other processes and references both the picture data and its metadata. In a real-world implementation, the represented database could be multiple entities, i.e. the image reference could be stored in a database and the image itself would be recorded in a blob or key-value storage. In a scenario where the pictures are acquired by other means than an autonomous device, such as pictures taken from manual rooftop inspections, the process could still apply, however acquiring all the images forming the basis of a series of determinations by the same camera a roof-mounted system all with same field of view, same camera orientation, may significantly increase the predictability and consistency of the system, and may therefore affect overall performance. The dashed line showing on FIG. 7 presents an example device picture acquisition algorithm which may operate independently from the rest of the processes.

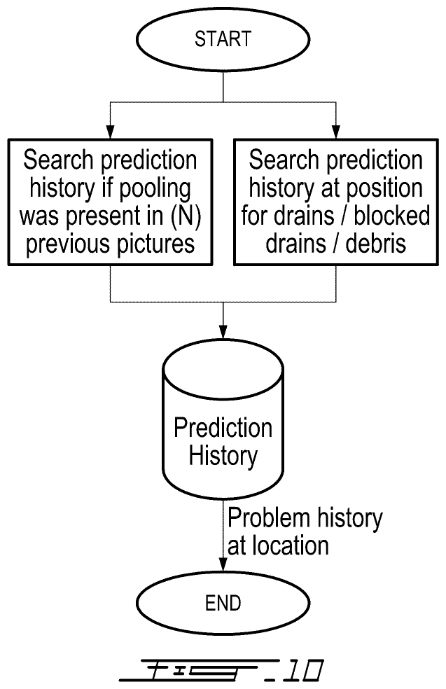

Given a “Device Pictures” database, the current process analyses a single instance of a picture to detect roof irregularities. This subprocess yields the predicted problems history input, including the presence and type of pooling at the location, which is saved in a form of storage. The process can be called in either a synchronous or asynchronous way. It could be triggered once a new image entry is saved in a database or in a planned way, whether ad-hoc or automated. FIG. 8 illustrates a flowchart representing the process in the novel system and method based on various CNN analyses of pictures. The triggered process begins where the input device pictures are obtained. The pictures undergo multiple different CNN analyses to detect the presence of a physical drain, debris on the roof, an obstructed physical drain, any type of pooling, and water pooling or pooling traces. Additionally, there is an optional CNN analysis for other related problems or causes of the problem. After each CNN analysis, the predictions results are integrated into the Prediction History database which holds the image reference, the predicted outputs and the confidence levels of each output. The system aims to enhance the efficiency and accuracy of pooling water alert generation by employing CNN analyses of device pictures to detect and assess potential pooling issues and related problems. While the system is primarily focused on detecting water pooling, as this is a recurring problem that causes a lot of damage, it is also capable of detecting other roof-related problems, whether they are the cause, the consequence, or a separate issue. This additional aptitude is put into practice by the optional process of analyzing an image for another type of roof problem. The last process linked by a dotted arrow illustrates this point. In another embodiment of the system, a single CNN, or one covering a subset of the problems, could be used to detect multiple problems. The choice of implementation depends on the performance and type of results required. For example, it could be implemented in a way that a multiple object detection model is used for a subset of the classes to be identified and a mask segmentation model for another, or for the whole. In such an embodiment, a single CNN can be trained to detect multiple problems.

Regardless of whether problems have already been detected before, the system bases its final analysis on meteorological data at the relevant location. This subprocess yields the validated weather data history input. To do this, the system gathers all the weather data available at the location, whether from a device equipped with rooftop weather sensors, from nearby stations, or from satellite or other data. Data from the various sources are collated and validated to ensure their accuracy, before being correlated with problems predicted in other sub-processes. The FIG. 9 illustrates the process of acquisition and analysis of localized weather data. The process begins by querying in-situ as well as ad loc. data. Historical weather data near the location of interest and the device's weather sensors history are queried independently. The historical weather data is obtained from weather history providers, through API calls and/or through a connection to weather station history database(s). Additionally, the device sensor's history is acquired. The acquired weather and sensor data are then analyzed, encompassing factors such as precipitation, humidity, temperature, and other factors. The process can validate the precipitation history at the location to ascertain its relevance. Multiple algorithms (i.e., interpolation, regression, anomaly detection and other techniques) can be utilized to achieve the desired accuracy. Finally, based on the analyzed and validated data, the process concludes by returning the corrected information. Although the use of on-site data is illustrated in the figure, it may be optional if at least another weather data source is available, and vice versa. For better performance, however, at least one weather data source may be present. The subprocess seeks to improve the accuracy and effectiveness of pooling water alert generation by leveraging localized weather data to make informed decisions and issue timely alerts when pooling water conditions are detected.

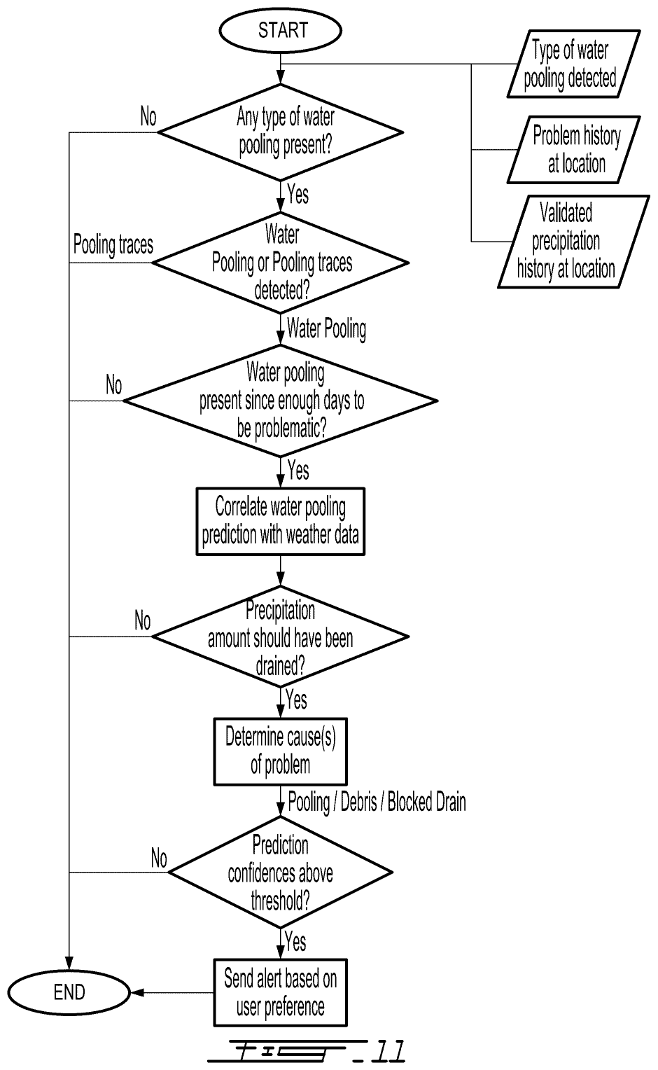

As previously mentioned, the presence of a single instance of water accumulation on a roof is not necessarily an issue. During periods of heavy rain, pooling may naturally occur as the drainage system becomes overwhelmed. However, this pooling is temporary and expected until the rain subsides, allowing the drain to evacuate the water or for evaporation to take place. To avoid false positives, the system tracks its predictions in a time-stamped history in order to qualify and quantify the magnitude and source of the problem. FIG. 10 outlines the retrieval of the prediction history and problem history at a specific location. This subprocess retrieves and yields the predicted problems history input from a storage, including the presence and type of pooling at the location. The process commences by branching into two steps. In the first step, the system searches the prediction history at the specified position to identify the presence of drains, blocked drains, or debris. In parallel, the second process examines the prediction history to determine if pooling was detected in the parameterized number of previous pictures. The number of pictures depends on the time interval between each picture. Alternatively, the system could query any number of pictures based on the date and time they were taken in order to cover an acceptable time period. The results from both processes are combined in a unified prediction history. Subsequently, the system cross-references the prediction history with the problem history at the location to ascertain the occurrence of any relevant pooling water issues in the past. The process ensures that pooling water alerts are issued based on thorough analysis of the prediction history and the historical presence of pooling water issues at the specific location, leading to improved alert accuracy and minimizing unnecessary alerts.

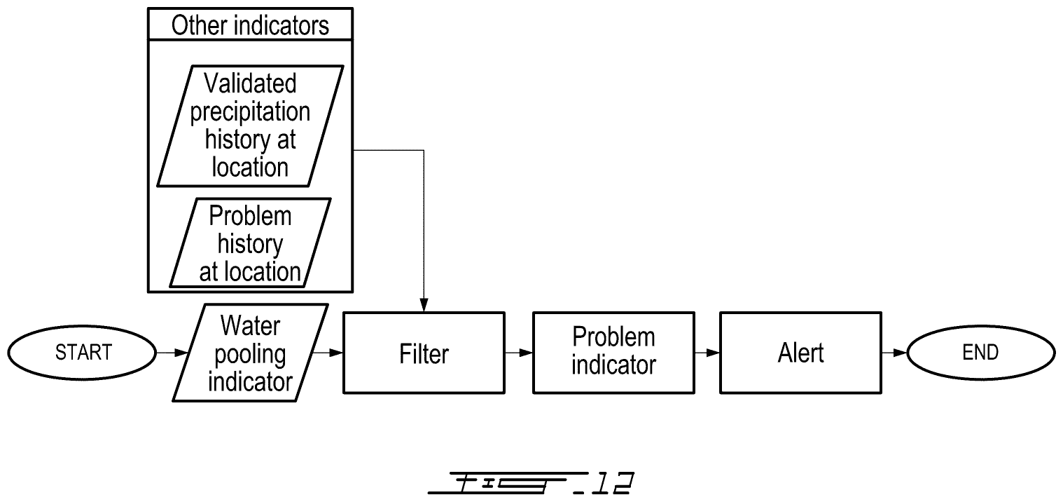

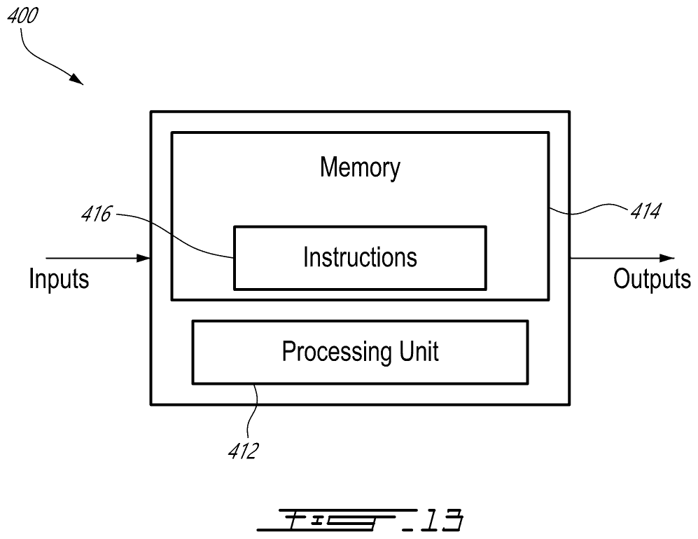

The alerting decision subprocess relates to the decision method for automatically determining whether to send a pooling water alert based on various inputs. FIG. 11 illustrates the decision process for automatically determining the appropriateness of issuing a pooling water alert.

The central challenge addressed by the system is the occurrence of false positive alerts, particularly during heavy rainfall. Such alerts might arise from temporary factors, noise, or anomalies, resulting in an unnecessary response.

The process requires inputs, including the type of water pooling detected, historical problem records at the location, and validated precipitation history. These inputs may be eagerly loaded and passed down the decision stream or alternatively being loaded at the moment they are required. The system first checks if any water pooling is detected, and if not, it concludes without sending an alert. For detected water pooling, the system differentiates between actual pooling and other types such as pooling traces. If only traces are present, no alert for pooling water is issued. However, if actual water pooling is identified, the system evaluates whether it has persisted long enough to be problematic. If so, the system correlates water pooling predictions with weather data to gain further insights. It then checks whether the precipitation should have been drained, and if so, it proceeds to analyze the causes of the problem. Cause analysis can be carried out using a traditional software algorithm, or a more advanced method based on machine learning or AI. Based on the confidence threshold of the predictions, the system sends an alert to the user's preference if the confidence is above the threshold, concluding the process. The process acts as a filter for several decisions. The exact filtering order is of little magnitude, as long as the end of the execution chain contains the information needed to determine the source of the problem and issue the appropriate alert if necessary. In the flowchart, three probable causes (pooling, debris, clogged drain) are illustrated, but other causes are also possible. These other problems would be supported by additional detection algorithms, implemented for example via other CNNs.

In essence, the system is designed to gather information on problems on the roof, validate their relevance and correlate them with their meteorological causes, in order to send relevant alerts where appropriate. The final implementation could have innumerable variations in the source and ordering of information, whether from the sub-processes described here or not. The system could also be used in applications other than roofing, as long as the problem detected is relevant to the new context. As shown in FIG. 7, the system could be implemented in a procedural way, without the need for sub-processing. This exercise simply illustrates the various rational components of the system.

The filtering process can be generalized as illustrated in FIG. 11. It starts with a water pooling indicator, which to be automated, is based on the AI vision model to assess the presence of pooling water. This indicator can also come from other sources. This indicator is augmented by other relevant data sources, including historical precipitation data and location-specific problem history. These indicators collectively traverse a filtering stage, where criteria are applied to validate the significance of the pooled information. If the criteria are met, an alert is generated, considering user preferences to ensure alerts are pertinent and actionable. This comprehensive approach allows for a nuanced and context-driven response to water pooling situations, mitigating the risk of false alarms and enhancing the system's overall efficiency.

Referring to FIG. 13, it will be understood that the expression “computer” 400 as used herein is not to be interpreted in a limiting manner. It is rather used in a broad sense to generally refer to the combination of some form of one or more processing units 412 and some form of memory system 414 accessible by the processing unit(s). The memory system can be of the non-transitory type. The use of the expression “computer” in its singular form as used herein includes within its scope the combination of a two or more computers working collaboratively to perform a given function. Moreover, the expression “computer” as used herein includes within its scope the use of partial capabilities of a given processing unit. A processing unit can be embodied in the form of a general-purpose micro-processor or microcontroller, a graphics processing unit (GPU), a digital signal processing (DSP) processor, an integrated circuit, a field programmable gate array (FPGA), a reconfigurable processor, a programmable read-only memory (PROM), to name a few examples.

The memory system can include a suitable combination of any suitable type of computer-readable memory located either internally, externally, and accessible by the processor in a wired or wireless manner, either directly or over a network such as the Internet. A computer-readable memory can be embodied in the form of random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) to name a few examples.

A computer can have one or more input/output (I/O) interface to allow communication with a human user and/or with another computer via an associated input, output, or input/output device such as a keyboard, a mouse, a touchscreen, an antenna, a port, etc. Each I/O interface can enable the computer to communicate and/or exchange data with other components, to access and connect to network resources, to serve applications, and/or perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, Bluetooth, WiMAX), SS7 signaling network, fixed line, local area network, wide area network, to name a few examples.

It will be understood that a computer can perform functions or processes via hardware or a combination of both hardware and software. For example, hardware can include logic gates included as part of a silicon chip of a processor. Software (e.g. application, process) can be in the form of data such as computer-readable instructions stored in a non-transitory computer-readable memory accessible by one or more processing units. With respect to a computer or a processing unit, the expression “configured to” relates to the presence of hardware or a combination of hardware and software which is operable to perform the associated functions. Different elements of a computer, such as processor and/or memory, can be local, or in part or in whole remote and/or distributed and/or virtual.

The methods and systems of the present disclosure may be implemented in a high level procedural or object oriented programming or scripting language, or a combination thereof, to communicate with or assist in the operation of a computer system, for example the controller. Alternatively, the methods and systems described herein may be implemented in assembly or machine language. The language may be a compiled or interpreted language. Program code for implementing the methods and systems described herein may be stored on a storage media or a device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein. Embodiments of the methods and systems described herein may also be considered to be implemented by way of a non-transitory computer-readable storage medium having a computer program stored thereon. The computer program may comprise computer-readable instructions which cause a computer, or more specifically the processing unit 402 of the computing device 400, to operate in a specific and predefined manner to perform the functions described herein, for example those described in the method 500.

Computer-executable instructions may be in many forms, including program modules, executed by one or more computers or other devices. Generally, program modules include routines, programs, objects, components, data structures, etc., that perform particular tasks or implement particular abstract data types. Typically the functionality of the program modules may be combined or distributed as desired in various embodiments. The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

As can be understood, the examples described above and illustrated are intended to be exemplary only. The scope is indicated by the appended claims.

What is claimed is:

1. A computer-implemented method of alerting a property manager of a pooling issue pertaining to a roof of a building, the method comprising:
providing image data including an image of the roof of the building;
determining that water pooling is present in the image the roof of the building, including processing the image of the roof of the building using a trained convolutional neural network;
providing contextual data pertaining to at least one of weather, history, and drain obstruction associated to the determined water pooling;
determining that the determined water pooling is indicative of the pooling issue, including validating a contextual criteria against the contextual data; and
transmitting an alert to the property manager contingent upon said determining that the determined water pooling is indicative of the pooling issue.

2. The computer-implemented method of claim 1 wherein said providing image data includes, using a camera, taking the image of the roof of the building, transmitting the image of the roof of the building over a telecommunications network, and storing the image of the roof of the building in a non-transitory computer-readable memory.

3. The computer-implemented method of claim 1 wherein said image data includes metadata associated to the image of the roof of the building, the metadata including a timestamp of a moment in time at which the image of the roof of the building was taken, wherein said validating the contextual criteria against the contextual data factors in the moment in time at which the image of the roof of the building was taken via the timestamp.

4. The computer-implemented method of claim 3 wherein the contextual criteria pertains contextual data dating from less than 4 days before the moment in time at which the image of the roof of the building was taken.

5. The computer-implemented method of claim 3 wherein the contextual data includes a weather history pertaining to a location at which the image of the roof of the building was taken, said validating the contextual criteria against the contextual data includes determining, from the weather history, an absence of rain at one or more moments in time preceding the moment in time at which the image of the roof of the building was taken.

6. The computer-implemented method of claim 3 wherein the image of the roof of the building is a first image of the roof of the building, the image data includes a plurality of additional images of the roof of the building taken at different moments in time associated to respective timestamps, the contextual data includes a history of previous determinations of whether or not water pooling was present in respective ones of the additional images of the roof, said validating the contextual criteria against the contextual data includes determining, from the history of previous determinations, an absence of rain at one or more of said different moments in time.

7. The computer-implemented method of claim 5 wherein the contextual data includes a weather history pertaining to a location at which the image of the roof of the building was taken, said validating the contextual criteria against the contextual data further includes determining, from the weather history, an absence of rain at one or more moments in time preceding the moment in time at which the image of the roof of the building was taken, said transmitting the alert to the property manager being contingent upon both said determining, from the history of previous determinations, the absence of rain at one or more of said different moments in time and determining, from the weather history, an absence of rain at one or more moments in time preceding the moment in time at which the image of the roof of the building was taken.

8. The computer-implemented method of claim 1 wherein the contextual data includes weather data pertaining to a location of the roof of the building, and said determining that the determined water pooling is indicative of the pooling issue includes validating an absence of rain in the weather data.

9. The computer-implemented method of claim 1 wherein the image of the roof of the building is a first image of the roof of the building, the image data includes a plurality of additional images of the roof of the building taken at different moments in time associated to respective timestamps, further comprising determining that a drain is present in at least one of the additional images of the roof using the trained convolutional neural network, wherein said determining that the determined water pooling is indicative of the pooling issue including validating that the drain was determined as present in at least one of the additional images of the roof.

10. The computer-implemented method of claim 1 wherein the image of the roof of the building is a first image of the roof of the building, the image data includes a plurality of additional images of the roof of the building taken at different moments in time associated to respective timestamps, further comprising determining that debris is present in at least one of the additional images of the roof using the trained convolutional neural network, storing said determination that debris is present in association with the respective at least one of the additional images of the roof, wherein said determining that the determined water pooling is indicative of the pooling issue includes validating that the debris was determined as present in said at least one of the additional images of the roof.

11. The computer-implemented method of claim 9 further comprising determining that a drain is present in at least one of the additional images of the roof using the trained convolutional neural network, wherein said determining that the determined water pooling is indicative of the pooling issue further includes validating that the drain was determined as present in at least one of the additional images of the roof.
